(19) United States
(12) Patent Application Publication
(10) Pub. No.: US 2014/0226023 A1
(43) Pub. Date: Aug. 14, 2014

(54) IMAGING APPARATUS, CONTROL METHOD, AND PROGRAM

(71) Applicant: Sony Corporation, Minato-ku (JP)

(72) Inventor: Akira FUKUDA, Kanagawa (JP)

(73) Assignee: Sony Corporation, Minato-ku (JP)

(21) Appl. No.: 14/105,786

(22) Filed: Dec. 13, 2013

(30) Foreign Application Priority Data
Feb. 13, 2013 (JP) 2013-025333

(51) Int. Cl. H04N 5/232

(52) U.S. Cl. CPC H04N 5/23212
USPC 348/169

(57) ABSTRACT

There is provided an imaging apparatus including an imaging unit configured to shoot an image of a subject, an AF area setting unit configured to set an AF area provided in an imaging area, the AF area being used for deciding a focus position of autofocus on the subject, and an AF control unit configured to control the autofocus in accordance with the AF area. When the subject that is a tracking target is not recognized in a tracking operation using the autofocus, the AF area setting unit sets the AF area again to a center of the imaging area.

### CROSS REFERENCE TO RELATED APPLICATIONS

This application claims the benefit of Japanese Priority Patent Application JP 2013-025333 filed Feb. 13, 2013, the entire contents of which are incorporated herein by reference.

### BACKGROUND

The present technology relates to an imaging apparatus, a control method, and a program. More particularly, the present technology relates to an imaging apparatus, a control method, and a program that reliably recognize a desired subject as a tracking target.

In recent years, digital still cameras such as digital single-lens reflex cameras and compact digital cameras have been in widespread use.

Some of the digital still cameras have functions of recognizing and tracking a subject. As one of methods for identifying a tracking target, the tracking function uses autofocus (which will also be referred to as “AF”) and recognizes a subject in focus as a tracking target.

The present applicant has proposed an imaging apparatus that can perform a tracking function using autofocus to keep the face of a subject in focus (see, for example, JP 2010-186004A).

Some digital still cameras have a function of selecting a distance-measuring area (which will be referred to as an “AF area”) provided in a photographing area, which is used while autofocusing. For example, it is possible herein to select “wide AF,” which uses multiple AF areas, “zone AF,” which uses multiple AF areas but unevenly disposes the multiple AF areas at the top, the bottom, the right, the left, or the center of an imaging area, “local AF,” which uses only a specific area, or “center-fixed AF,” which uses only the center of an imaging area.

### SUMMARY

When a subject brought into focus by autofocus is recognized as a tracking target, it is requested to reliably bring the subject that a user desires to photograph into focus. However, when there is an obstruction in front of a subject that a user desires to photograph or there is an object having higher contrast in the vicinity of the subject that the user desires to photograph, the obstruction or the object other than the subject that the user desires to photograph generally comes into focus upon use of the wide AF, which uses multiple AF areas.

On such occasions, the object other than the subject that the user actually desires to photograph is recognized as a tracking target. A technique has therefore been sought for that accurately brings the subject that is a tracking target into focus and correctly recognizes the tracking target.

The present technology is proposed in view of such circumstances, and it becomes possible to reliably recognize a desired subject as a tracking target.

According to an embodiment of the present technology, there is provided an imaging apparatus including an imaging unit configured to shoot an image of a subject, an AF area setting unit configured to set an AF area provided in an imaging area, the AF area being used for deciding a focus position of autofocus on the subject, and an AF control unit configured to control the autofocus in accordance with the AF area. When the subject that is a tracking target is not recognized in a tracking operation using the autofocus, the AF area setting unit sets the AF area again to a center of the imaging area.

When multiple AF areas disposed at given positions in the imaging area are set as the AF area, the AF area setting unit may set the AF area to the center again.

The AF area setting unit may set the AF area again to the multiple AF areas disposed at the given positions in the center.

The AF area setting unit may set the AF area again to one of the AF areas disposed at the given positions in the center.

The imaging apparatus may further include a subject recognition unit configured to recognize the subject that is the tracking target. The AF area setting unit may set the AF area again in accordance with a recognition result of the subject recognition unit.

The imaging apparatus may be an independent apparatus, or may also be an internal block included in a single apparatus.

According to an embodiment of the present technology, there are provided a control method and a program corresponding to the imaging apparatus according to the embodiment of the present technology.

According to another embodiment of the present technology, there are provided an imaging apparatus, a control method, and a program, the control method including setting, by the imaging apparatus, an AF area provided in an imaging area, the AF area being used for deciding a focus position of autofocus on the subject, controlling, by the imaging apparatus, the autofocus in accordance with the AF area, and setting, by the imaging apparatus, the AF area again to a center of the imaging area when the subject that is a tracking target is not recognized in a tracking operation using the autofocus.

According to one or more of embodiments of the present technology, it is possible to reliably recognize a desired subject as a tracking target.

### BRIEF DESCRIPTION OF THE DRAWINGS

FIG. 1 is a diagram illustrating a configuration of a digital still camera according to an embodiment, to which the present technology is applied;

FIG. 2 is a flowchart for describing tracking processing;

FIG. 3 is a flowchart for describing first AF area setting processing;

FIG. 4 is a flowchart for describing second AF area setting processing;

FIG. 5 is a diagram illustrating a specific example of a wide area;

FIG. 6 is a diagram illustrating a specific example of a center-fixed area;

FIG. 7 is a diagram illustrating a specific example of a zone central area; and

FIG. 8 is a diagram illustrating a configuration example of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

With reference to the drawings, embodiments of the present technology will be described below.

### <Configuration Example of Digital Still Camera>

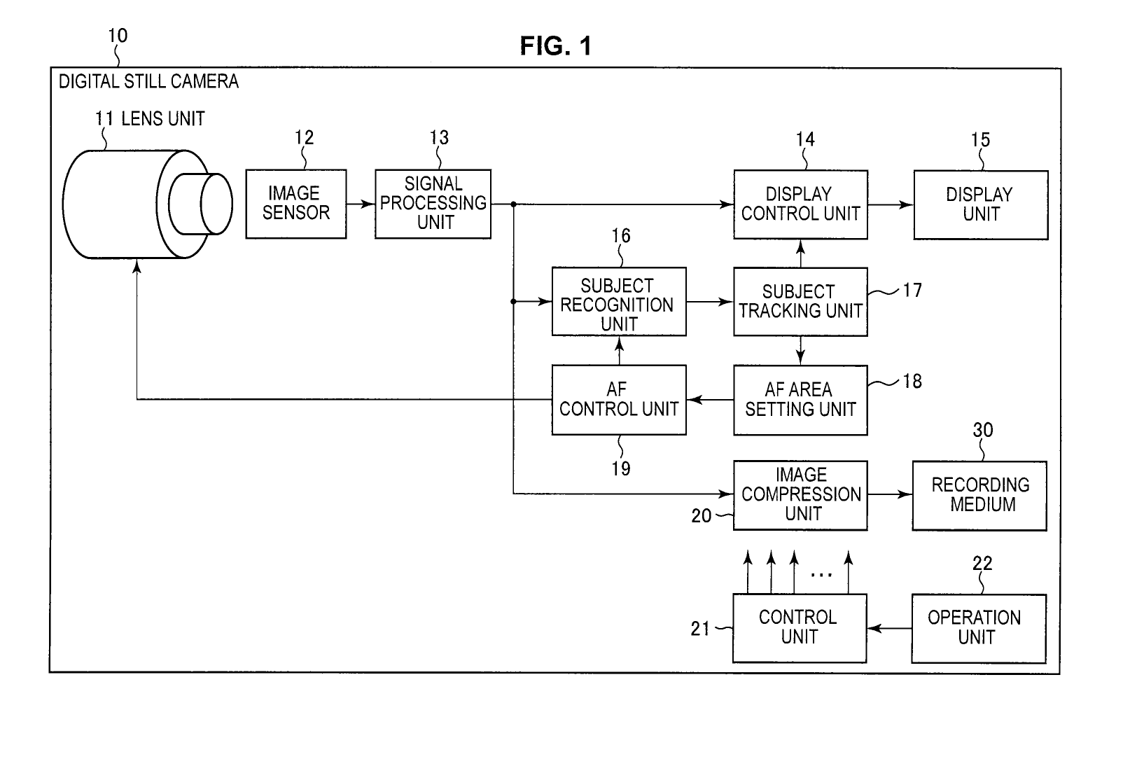

FIG. 1 is a diagram illustrating a configuration of a digital still camera according to an embodiment, to which the present technology is applied.

A digital still camera 10 is, for example, a digital single-lens reflex camera or a digital compact camera that records, as image data in the form of digital signals, a shot image that is shot by a solid-state image sensor.

The digital still camera 10 includes a lens unit 11, an image sensor 12, a signal processing unit 13, a display control unit 14, a display unit 15, a subject recognition unit 16, a subject tracking unit 17, an AF area setting unit 18, an AF control unit 19, an image compression unit 20, a control unit 21, and an operation unit 22. A recording medium 30 having the image data of the shot image recorded thereon is attached to the digital still camera 10 as necessary.

The image sensor 12 includes a solid-state image sensor such as a complementary metal oxide semiconductor (CMOS) sensor. The image sensor 12 receives light from a subject, which is incident via the lens unit 11, and performs photoelectric conversion. The image sensor 12 supplies analog image signals according to an amount of received light to the signal processing unit 13.

The signal processing unit 13 applies analog signal processing such as amplification to the analog image signals from the image sensor 12, and further performs analog/digital (A/D) conversion on the resultant image signals. The signal processing unit 13 also applies digital signal processing such as noise removal processing to the image data in the form of digital signals obtained through the A/D conversion, and supplies the resultant image data to the display control unit 14, the subject recognition unit 16, and the image compression unit 20.

The display control unit 14 causes the display unit 15 to display the shot image corresponding to the image data from the signal processing unit 13. The display unit 15 includes, for example, a liquid crystal display (LCD) and an organic electroluminescence display (OELD).

The subject recognition unit 16 is supplied with information (which will be referred to as “focus position information”) indicating a focus position for autofocus on a subject from the AF control unit 19 in addition to the image data from the signal processing unit 13. For example, the focus position information includes information indicating a position on the image sensor 12, which identifies the focus position.

The subject recognition unit 16 recognizes a subject (object) present at the focus position in the shot image as a tracking target on the basis of the focus position information from the AF control unit 19, and extracts a feature amount thereof. The subject recognition unit 16 supplies the subject tracking unit 17 with information (which will be referred to as “tracking target information”) such as the feature amount of the tracking target, which indicates a result of recognizing the subject that is a tracking target.

The subject tracking unit 17 performs tracking processing on the tracking target present in the shot image on the basis of the tracking target information from the subject recognition unit 16. For example, the subject recognition unit 16 cooperates with the subject tracking unit 17 in the tracking processing so that the tracking target present in the shot image, which is periodically output from the signal processing unit 13, is identified, and information regarding a position of the tracking target on the shot image is acquired on the basis of the feature amount of the tracking target, which is periodically acquired as the tracking target information.

The subject tracking unit 17 supplies the display control unit 14 with information (which will be referred to as “tracking frame information”) indicating a superimposition position represented by a frame that has a predetermined shape and is superimposed on the tracking target in the shot image, on the basis of the position information acquired as a result of the tracking processing.

The display control unit 14 is supplied with the tracking frame information from the subject tracking unit 17 in addition to the image data from the signal processing unit 13. The display control unit 14 superimposes the tracking frame on the shot image on the basis of the tracking frame information from the subject tracking unit 17. As a result, the display unit 15 displays the superimposed tracking frame such that the tracking frame follows the tracking target subject on the shot image.

The subject tracking unit 17 supplies the AF area setting unit 18 with information (which will be referred to as “tracking state information”) indicating a state of the tracking target on the basis of the result of the tracking processing. The tracking state information includes information indicating whether the tracking target has been recognized.

The AF area setting unit 18 sets an AF area for deciding a focus position for autofocus on the subject. Here, an AF area according to a range such as the above-described “wide AF,” “zone AF,” “local AF,” and “center-fixed AF” in which autofocus functions is set.

An AF area in the case where the wide AF is selected, an AF area in the case where the zone AF is selected, an AF area in the case where the local AF is selected, and an AF area in the case where the center-fixed AF is selected will be referred to as a “wide area,” a “zone area,” a “local area,” and a “center-fixed area,” respectively. A central zone area of the zone area in the imaging area will be referred to as a “zone central area.”

When the subject that is a tracking target is not recognized on the basis of the tracking state information from the subject tracking unit 17, the AF area setting unit 18 also sets the AF area to the center-fixed area or the zone central area again. When the subject that is a tracking target is recognized on the basis of the tracking state information from the subject tracking unit 17, the AF area setting unit 18 further sets the AF area to the wide area again.

The AF area setting unit 18 supplies the AF control unit 19 with information (which will be referred to as “AF area information”) regarding the AF area that is set (set again).

The AF control unit 19 brings the subject into focus by moving, in an optical axis direction, a focus lens of the lens group disposed inside the lens unit 11 on the basis of the AF area information from the AF area setting unit 18. The AF control unit 19 also supplies the subject recognition unit 16 with the focus position information indicating the focus position of the subject that is a tracking target.

The image compression unit 20 compresses the image data from the signal processing unit 13 in accordance with a predetermined compression scheme such as the Joint Photographic Experts Group (JPEG) scheme under the control of the control unit 21. The image compression unit 20 records the compressed image data on the recording medium 30. The recording medium 30 is a recording medium such as a memory card, and is detachably attached to the digital still camera 10 with ease.

The control unit 21 controls an operation of each unit in the digital still camera 10. The control unit 21 also performs various processes in accordance with signals from the operation unit 22.

The operations unit 22 corresponds to various buttons, switches, and the like such as a shutter button, a zoom button, a mode dial, a power switch, and an operation button for operating a setting screen, which is provided on the digital still camera 10. When the buttons and the like are operated, the operation unit 22 supplies the control unit 21 with signals according to the respective operations.

The image sensor 12 receives light from a subject, which is incident via the lens unit 11, performs photoelectric conversion, and outputs the resultant analog image signals in the digital still camera 10 configured as described above. The analog image signals that are output by the image sensor 12 go through the signal processing unit 13 so that the analog image signals are converted into image data in the form of digital signals and supplied to the display control unit 14. As a result, the display unit 15 displays the shot image as a live view image.

Thereafter, when the user operates the shutter button, a signal according to the operation is supplied from the operation unit 22 to the control unit 21. When the control unit 21 is supplied with the signal according to the operation on the shutter button, the control unit 21 controls the signal processing unit 13 and the image compression unit 20 to compress the image data, on which A/D conversion has been performed, in the JPEG scheme, and to record the resultant image data on the recording medium 30.

As described above, a so-called photograph is taken.

The digital still camera 10 also has an autofocus function. The AF control unit 19 causes the digital still camera 10 to automatically bring a subject into focus by moving the focus lens disposed inside the lens unit 11 in the optical axis direction. The digital still camera 10 further has a tracking function using autofocus. Accordingly, the digital still camera 10 can perform a tracking operation of capturing a subject that is a tracking target, and keeping the subject in focus. Next, tracking processing executed by the digital still camera 10 will be described.

### <Tracking Processing>

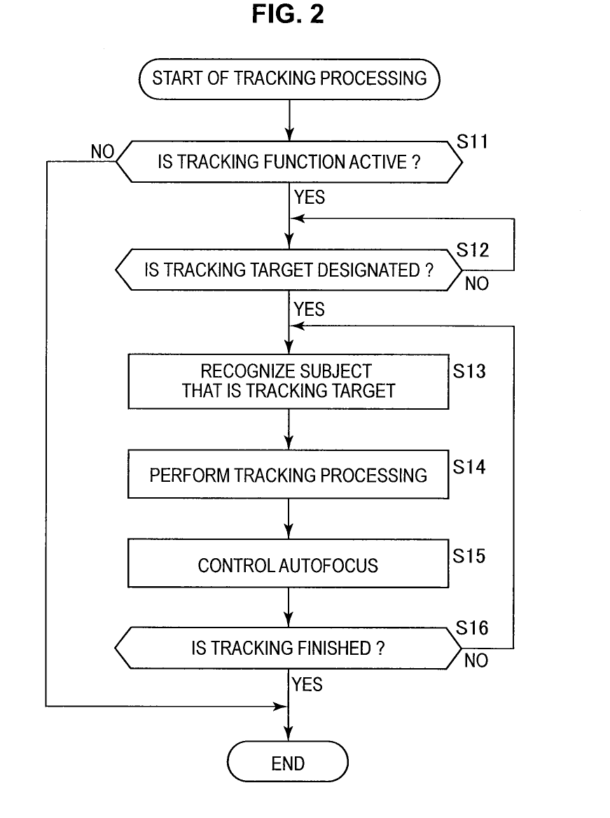

FIG. 2 is a flowchart for describing the tracking processing executed by the digital still camera 10 illustrated in FIG. 1.

In step S11, the control unit 21 determines whether a user sets the tracking function active. If it is determined, in step S11, that the tracking function is active, the processing proceeds to step S12. If the tracking function is not active, the tracking processing illustrated in FIG. 2 is not performed and the processing ends.

In step S12, the control unit 21 determines whether a subject that is a tracking target is designated, on the basis of a signal from the operation unit 22.

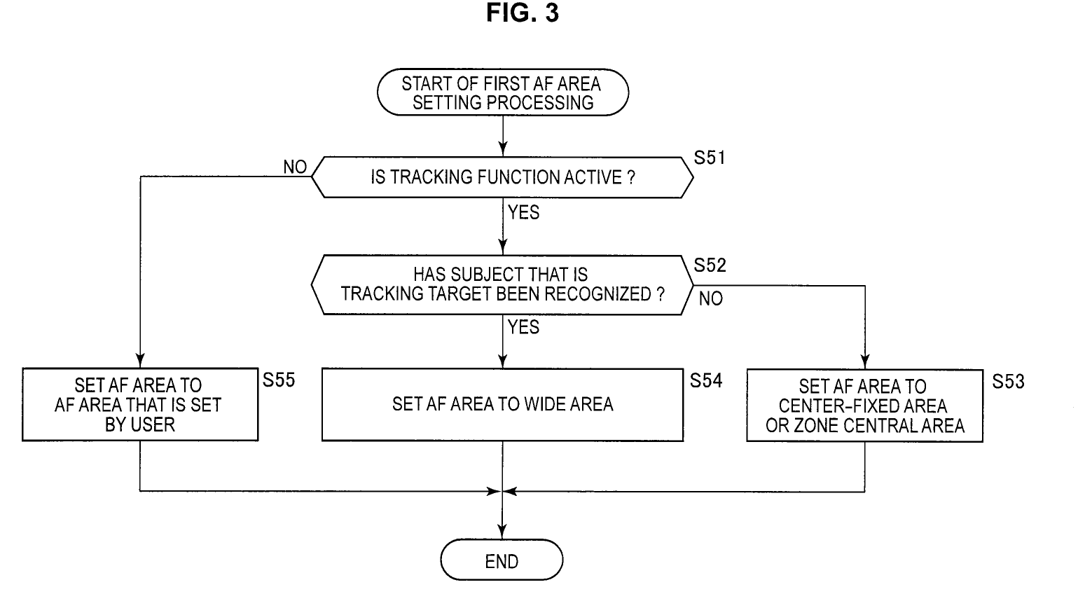

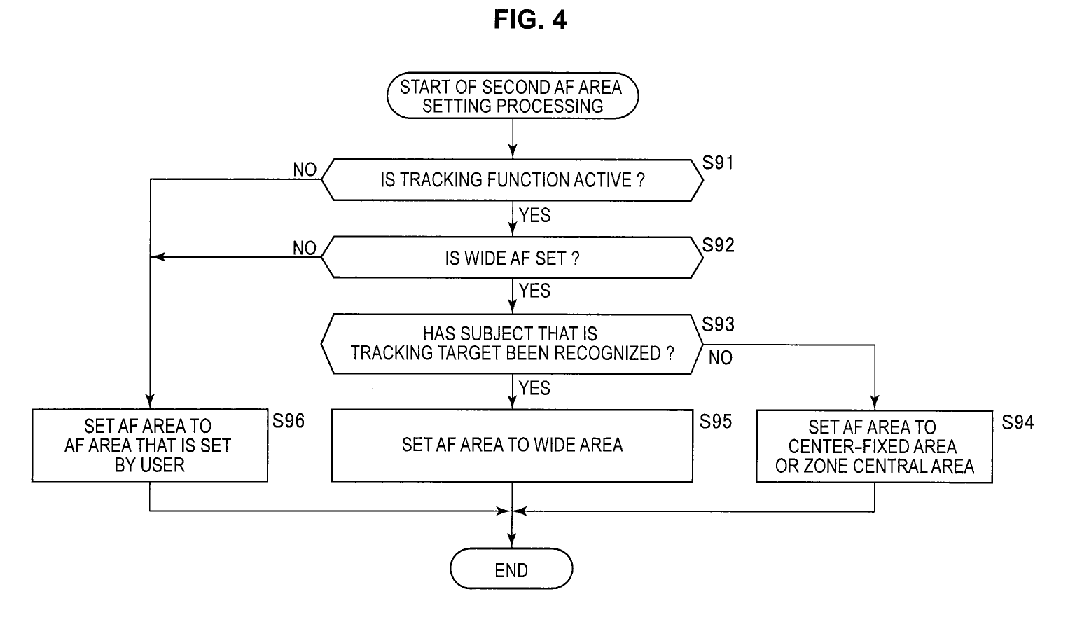

For example, the user can designate the subject as a tracking target by performing a predetermined operation such as pressing the shutter button halfway down with the subject that the user desires to photograph in focus while watching a shot image displayed on the display unit 15 as a live view image. The AF area information used upon AF control is set as appropriate by the AF area setting unit 18. The detailed processes will be described below with reference to flowcharts illustrated in FIGS. 3 and 4.

After the tracking target is designated in step S12, the processing proceeds to step S13.

In step S13, the subject recognition unit 16 recognizes the subject that is a tracking target and is designated by the user from the shot image, on the basis of the focus position information from the AF control unit 19.

In step S14, the subject tracking unit 17 performs processing of tracking the tracking target present in the shot image on the basis of the tracking target information from the subject recognition unit 16. For example, when the subject that is a tracking target is the face of some person, a feature amount of a feature point included in an organ of the face is extracted from the shot image. Accordingly, the person who is a tracking target is identified in accordance with the feature amount.

Additionally, various techniques have been proposed as the techniques of recognizing a subject such as a person included in a shot image, and tracking the subject as a tracking target. Any of such known techniques can be adopted for the processes in steps S13 and S14.

In step S15, the AF control unit 19 moves the focus lens disposed inside the lens unit 11 in the optical axis direction on the basis of the AF area information from the AF area setting unit 18 so that the subject that is a tracking target comes into focus.

The AF area information used upon AF control is set as appropriate by the AF area setting unit 18. The detailed processes will be described with reference to the flowcharts illustrated in FIGS. 3 and 4.

In step S16, the control unit 21 determines whether to finish tracking the subject that is a tracking target. If it is determined, in step S16, to keep tracking the subject, the processing returns to step S13 and the following processes are repeated.

That is, the processes in steps S13 to S16 are repeated so that the digital still camera 10 keeps focusing on the subject, who the user is aiming at, and performs the tracking operation by superimposing the tracking frame on the shot image displayed on the display unit 15 as a live view image such that the tracking frame follows the subject that is a tracking target. As a result, the user can reliably photograph a subject that the user desires to photograph by confirming the image displayed as a live view image and pressing the shutter button at timing at which a desired shot image is acquired.

If it is determined, in step S16, to finish tracking the subject that is a tracking target, the tracking processing illustrated in FIG. 2 ends.

As above, the tracking processing has been described.

### <AF Area Setting Processing>

Next, AF area setting processing executed by the AF area setting unit 18 will be described.

(First AF Area Setting Processing)

First of all, with reference to the flowchart illustrated in FIG. 3, first AF area setting processing will be described. The AF area setting processing is repeatedly executed at predetermined timing such as taking a photograph and executing the tracking processing.

In step S51, the AF area setting unit 18 determines under the control of the control unit 21 whether a user sets the tracking function active. When it is determined, in step S51, that the tracking function is active, the processing proceeds to step S52.

In step S52, the AF area setting unit 18 determines whether a subject that is a tracking target has been recognized, on the basis of the tracking state information from the subject tracking unit 17.

If it is determined, in step S52, that the subject that is a tracking target has not been recognized, the processing proceeds to step S53. In step S53, the AF area setting unit 18 sets the AF area to the center-fixed area or the zone central area again.

That is, if an AF area other than an area in the center of the imaging area is active, the AF area other than the center of the imaging area comes into focus though the subject is not in the center of the imaging area. In this case, when there is an obstruction in front of the subject that the user desires to photograph, the unintended object is likely to come into focus in the AF area other than the center. That is, if an AF area other than the center is active when the subject that is a tracking target is not recognized, an object other than the subject that the user desires to photograph is likely to come into focus and the tracking target is likely to be misrecognized.

Accordingly, when a subject that is a tracking target is not recognized, the AF area is set to the center-fixed area again. Consequently, the subject that the user desires to photograph can come into focus in an AF area in the center of the imaging area regardless of the presence of an obstruction in front of the subject. When there is an object having higher contrast in the vicinity of the subject that the user desires to photograph, the subject that the user desires to photograph can come into focus in an AF area in the center of the imaging area regardless of the presence of the object.

If the AF area is set to the zone central area again instead of the center-fixed area, only an AF area in the center of the imaging area is activated. Accordingly, even if there is an obstruction in front of a user or an object having high contrast, the subject that the user desires to photograph comes into focus in the AF area in the center.

When a subject that is a tracking target is not recognized, only an AF in the center is activated in this way so that the subject that the user desires to photograph can be reliably recognized as a tracking target regardless of the presence of another object in the imaging area.

If it is determined, in step S52, that a subject that is a tracking target has been recognized, the processing proceeds to step S54. In step S54, the AF area setting unit 18 sets the AF area to the wide area again.

That is, before the process of recognizing the subject that is a tracking target (steps S11 to S12 illustrated in FIG. 2, for example), the AF area is set again to the center-fixed area or the zone central area by the process in step S53. Meanwhile, after the process of recognizing the subject that is a tracking (steps S13 to S16 illustrated in FIG. 2, for example), the AF area is set to the wide area again by the process in step S54.

In other words, different AF areas are set in a tracking mode of performing a tracking operation and a tracking preparation mode of preparing for the tracking operation in the digital still camera 10. Once the tracking operation is started and the tracking preparation mode shifts to the tracking mode, the AF area is fixed.

If it is determined, in step S51, that the tracking function is not active, the processing proceeds to step S55. In this case, the tracking processing illustrated in FIG. 2 is not performed. Accordingly, in step S55, the AF area setting unit 18 sets the AF area to an AF area that is set by the user.

For example, when the user sets the wide AF, the wide area is set as the AF area. When the center-fixed AF is set, the center-fixed area is set as the AF area.

When any process in steps S53, S54, and S55 sets the AF area, the AF area setting processing illustrated in FIG. 3 ends.

As above, the first AF area setting processing has been described.

(Second AF Area Setting Processing)

When a subject that is a tracking target is not recognized in the first AF area setting processing regardless of setting of a range in which autofocus functions, only an AF area in the center of the imaging area is compulsorily activated. However, it may also be determined in accordance with the setting whether to activate the AF area in the center. Next, it will be described that the AF area in the center is activated when the wide AF is set as second AF setting processing.

FIG. 4 is a flowchart for describing the second AF area setting processing.

In step S91, it is determined whether a user sets the tracking function active, in the same way as step S51 illustrated in FIG. 3. If the tracking function is set active, the processing proceeds to step S92.

In step S92, the AF area setting unit 18 determines under the control of the control unit 21 whether the wide AF is set as autofocus. If it is determined, in step S92, that the wide AF is set, the processing proceeds to step S93.

In step S93, it is determined whether a subject that is a tracking target has been recognized, in the same way as step S52 illustrated in FIG. 3.

If it is determined, in step S93, that the subject that is a tracking target has not been recognized, the processing proceeds to step S94. In step S94, the AF area setting unit 18 sets the AF area to the center-fixed area or the zone central area. As a result, the AF area is changed from the wide area to the center-fixed area or the zone central area.

For example, a given AF area of multiple AF areas in the imaging area is used for focusing in the wide AF. However, if the wide area is set as the AF area, the given AF area comes into focus even when a subject is not present in the center of the imaging area. In this case, when there is an obstruction in front of the subject that a user desires to photograph, the unintended object is likely to come into focus in any of the multiple AF areas. That is, when the subject that is a tacking target is not recognized and the wide area is set, an object other than the subject that the user desires to photograph is likely to come into focus and the tracking target is also likely to be misrecognized.

Accordingly, when a subject that is a tacking target is not recognized, the AF area is set again from the wide area to the center-fixed area. As a result, the subject that a user desires to photograph can come into focus in an AF area in the center of the imaging area regardless of the present of an obstruction in front of the subject. Similarly, when there is an object having higher contrast in the vicinity of the subject that a user desires to photograph, the subject that the user desires to photograph can come into focus in an AF area in the center of the imaging area regardless of the presence of such an object.

If the AF area is set to the zone central area instead of the center-fixed area, the similar effect can be attained, as described above.

If it is determined, in step S93, that the subject that is a tracking target has been recognized, the processing proceeds to step S95. In step S95, the AF area setting unit 18 sets the AF area to the wide area. As a result, the AF area is changed from the center-fixed area or the zone central area to the wide area, and remains fixed to the wide area while the tracking processing is performed.

If it is determined, in step S91, that the tracking function is not active, or if it is determined, in step S92, that the wide AF is not set, the processing proceeds to step S96. In step S96, the AF area is set to an AF area that is set by a user, in the same way as step S55 illustrated in FIG. 3. That is, if autofocus other than the wide AF is set, the AF area is set to an AF area that is set by a user.

As above, with respect to the second AF area setting processing, the process of activating only an AF area in the center in the case where the wide AF is set has been described. Since the wide AF is easy to be brought into focus, and is supposed to be used mainly by beginners, only an AF area in the center is activated for the beginner users to reliably track a desired subject as a tracking target when the beginner users use the tracking function. To the contrary, since the zone AF and the local AF are supposed to be used mainly by experienced users, the users' will is respected when the experienced users use the tracking function. That is, not only an AF area in the center is activated when a tracking subject has been not recognized. Instead, the users can designate a tracking target using autofocus that the users set.

However, the above-described second AF area setting processing is just an example. When autofocus such as the zone AF and the local AF other than the wide AF is set, only an AF area in the center of the imaging area may be activated.

As above, the second AF area setting processing has been described.

### <Specific Examples of AF Areas>

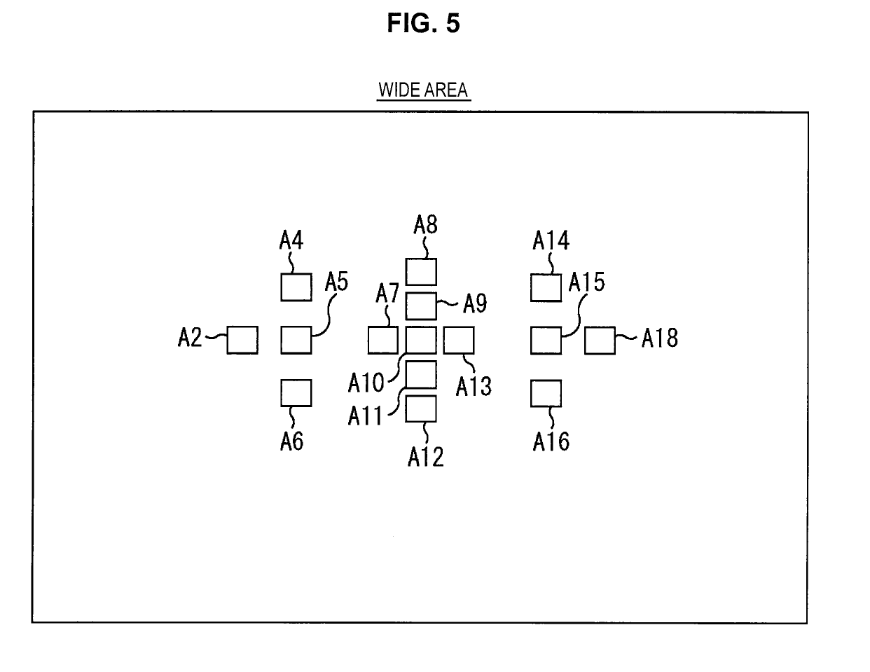

Next, with reference to FIGS. 5 to 7, specific examples of AF areas are shown. A quadrangular fixed pattern represents a single AF area in FIGS. 5 to 7.

Additionally, an AF sensor (not shown) capable of detecting focus states at multiple points is installed in the digital still camera 10. In the examples, AF areas according to 19 focus state detection points are illustrated. The AF areas are divided into three groups. The AF areas can be classified into six left AF areas (A1 to A6), seven central AF areas (A7 to A13), and six right AF areas (A14 to A19).

(Wide Area)

FIG. 5 illustrates a specific example of the wide area. As illustrated in FIG. 5, the wide area includes four left AF areas (A2, and A4 to A6), seven central AF areas (A7 to A13), and four right AF areas (A14 to A16, and A18). Any given AF area of the 15 AF areas disposed at any given positions in the imaging area is used for focusing in the wide area. Accordingly, if a subject that is a tracking target is not recognized, an object other than the subject that a user desires to photograph is likely to come into focus.

(Center-Fixed Area)

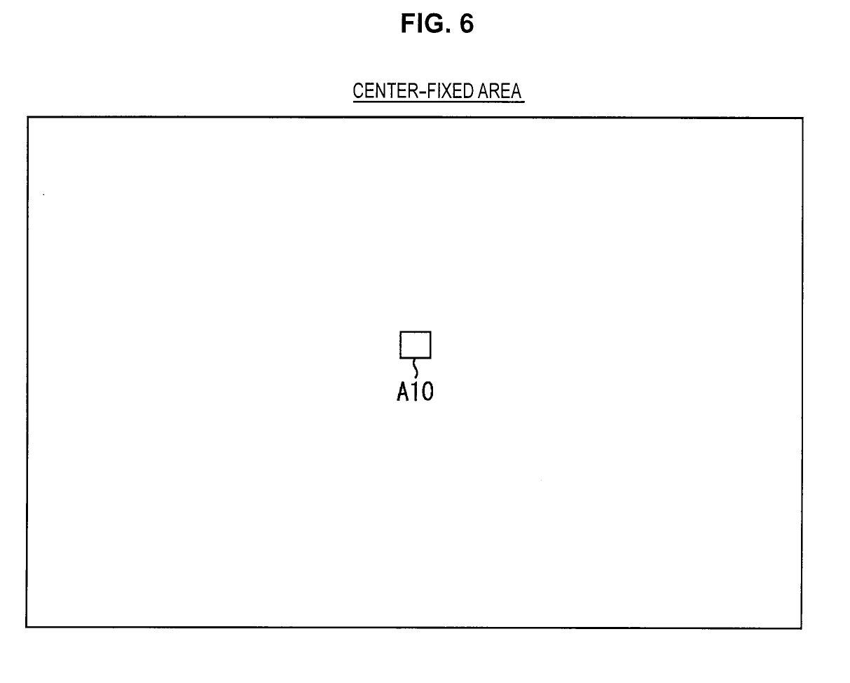

FIG. 6 illustrates a specific example of the center-fixed area. The center-fixed area includes only a single AF area (A10) in the center. Only the single AF area disposed at any given position in the center is used for focusing in the center-fixed area. Accordingly, a subject that a user desires to photograph can come into focus in the AF area in the center regardless of the presence of an obstruction in front of the subject.

(Zone Central Area)

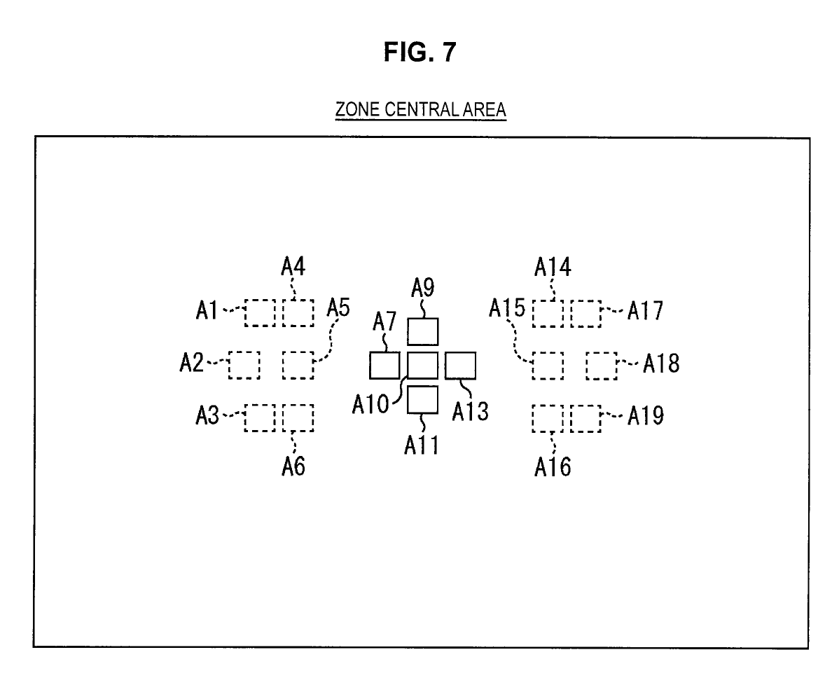

FIG. 7 illustrates a specific example of the zone central area. For example, the zone area includes multiple AF areas such as six left AF areas (A1 to A6), five central AF areas (A7, A9 to A11, and A13), and six right AF areas (A14 to A19), which are unevenly disposed at the top, the bottom, the left, the right, or the center. As described above, the five central AF areas (A7, A9 to A11, and A13) of the zone area, which are shown as solid line fixed patterns illustrated in the figure, are referred to as a zone central area.

Any given AF area of the five AF areas disposed at any given positions in the center is used for focusing in the zone central area. Accordingly, a subject that a user desires to photograph can come into focus in an AF area in the center regardless of the presence of an obstruction in front of the subject.

In this way, only an AF area in the center is activated in both the center-fixed area (FIG. 6) and the zone central area (FIG. 7), and a subject that a user desires to photograph can come into focus in each active AF area. However, comparing the two areas, the center-fixed area includes fewer activated AF areas (only a single AF area disposed at any given position in the center is activated) in the center than the zone central area. Accordingly, the center-fixed area is less influenced by the presence of an obstruction in front of a subject.

To the contrary, the zone central area includes more activated AF areas (multiple AF areas disposed at any given positions in the center are activated) in the center than the center-fixed area. Accordingly, a subject that a user desires to photograph is likely to come into focus.

Thus, it is preferable that an AF area activated in the center be set by taking the effects into consideration. If a subject that is a tracking target is not recognized, the center-fixed area (FIG. 6) or the zone central area (FIG. 7) is set again instead of the wide area (FIG. 5) so that a desired subject can be reliably recognized as a tacking target.

Additionally, the center-fixed area and the zone central area, which are each set again as the AF area if a subject that is a tracking target has not been recognized, are just examples. Another area included in the center of the imaging area may also be set. The AF areas illustrated in FIGS. 5 to 7 may be displayed on a finder (not shown), and displayed on the display unit 15 along with the shot image.

As above, the specific examples of the AF areas have been described.

As described above, according to the embodiments of the present technology, when a subject that is a tracking target is not recognized in a tracking operation using autofocus, it is possible to reliably recognize a desired subject as a tracking target by setting the AF area again to the center of an imaging area.

It has been described for convenience of explanation that an image sensor that acquires image data for live view display is the same as an image sensor that acquires image data to be recorded on the recording medium 30. However, the image sensors can also be separately configured.

Although no schemes for autofocus have been mentioned above, various schemes such as phase difference AF, contrast AF, and a combination thereof can be adopted. However, if phase difference AF is adopted, a dedicated AF sensor (not shown) is installed.

A digital still camera has been used as an example in the description above. However, the embodiments of the present disclosure can also be applied to another imaging apparatus such as a digital video camera that has an imaging function.

<Description of Computer to which Present Technology is Applied>

The above-described sequence of processes can be executed by hardware or software. When the sequence of processes is performed by software, a program included in the software is installed in a computer. The computer includes, for example, a computer included in dedicated hardware or a general-purpose personal computer that have various programs installed therein and can execute various functions.

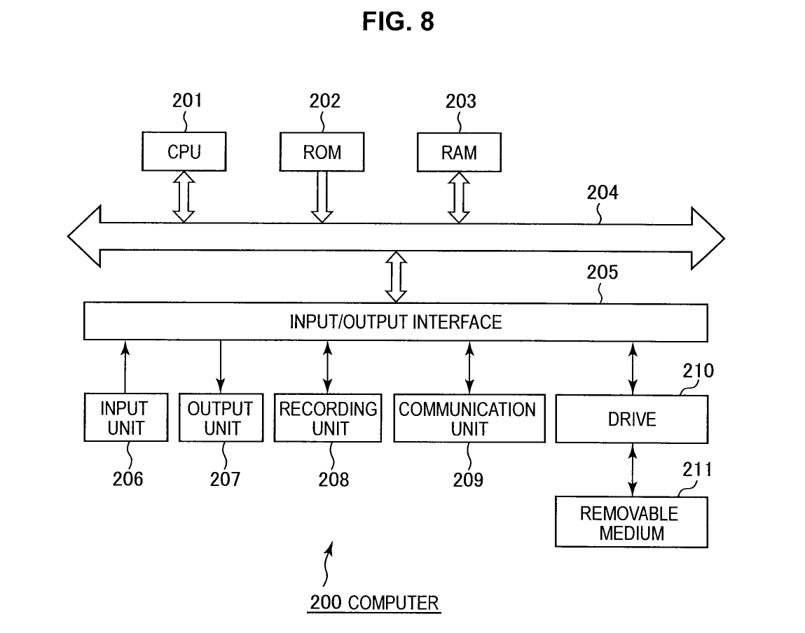

FIG. 8 is a block diagram illustrating a configuration example of hardware of a computer that executes the sequence of processes with a program.

A central processing unit (CPU) 201, read only memory (ROM) 202, and random access memory (RAM) 203 are interconnected by a bus 204 in a computer 200.

An input/output interface 205 is further connected to the bus 204. An input unit 206, an output unit 207, a recording unit 208, a communication unit 209, and a drive 210 are connected to the input/output interface 205.

The input unit 206 includes, for example, a keyboard, a mouse, and a microphone. The output unit 207 includes, for example, a display and a speaker. The recording unit 208 includes, for example, a hard disk and a non-volatile memory. The communication unit 209 includes, for example, a network interface. The drive 210 drives a removable medium 211 such as a magnetic disk, an optical disc, a magneto-optical disk, and a semiconductor memory.

In the computer 200 configured as described above, the CPU 201 loads a program, for example, stored in the recording unit 208 to the RAM 203 via the input/output interface 205 and the bus 204, and executes the program so that the sequence of processes is performed.

A program executed by the computer 200 (CPU 201) can be recorded on the removable medium 211, which has been configured, for example, like a package medium, and can be provided. The program can also be provided via a wired or wireless transmission medium such as a local area network, the Internet, and digital satellite broadcasting.

The removable medium 211 is attached to the drive 210 in the computer 200 so that a program can be installed in the recording medium 208 via the input/output interface 205. The program can also be received by the communication unit 209 via a wired or wireless transmission medium, and can be installed in the recording medium 208. In addition, the program can also be installed in the ROM 202 or the recording medium 208 in advance.

Additionally, a program executed by the computer 200 may be a program of which processes are performed in chronological order as described herein, in parallel, or at necessary timing at which, for example, the program is invoked.

Processing steps that writes a program for causing the computer 200 to perform various processes are not herein necessarily performed in chronological order as described as flowcharts. The processing steps also include processes (such as parallel processing or processing by an object) that are executed in parallel or individually.

The program may be processed by a single computer or distributedly processed by multiple computers. The program may also be transferred to a remote computer and executed therein.

It should be understood by those skilled in the art that various modifications, combinations, sub-combinations and alterations may occur depending on design requirements and other factors insofar as they are within the scope of the appended claims or the equivalents thereof.

For example, an embodiment of the present technology can adopt a cloud computing configuration, in which multiple apparatuses share a single function via a network and perform processes in cooperation with one another.

The respective steps described in the flowcharts can be not only performed by a single apparatus, but also shared and performed by multiple apparatuses. Furthermore, if multiple processes are included in a single step, the multiple processes included in the single step can be not only executed by a single apparatus, but also shared and executed by multiple apparatuses.

Additionally, the present technology may also be configured as below.

(1) An imaging apparatus including:

an imaging unit configured to shoot an image of a subject;

an AF area setting unit configured to set an AF area provided in an imaging area, the AF area being used for deciding a focus position of autofocus on the subject; and

an AF control unit configured to control the autofocus in accordance with the AF area,

wherein, when the subject that is a tracking target is not recognized in a tracking operation using the autofocus, the AF area setting unit sets the AF area again to a center of the imaging area.

(2) The imaging apparatus according to (1),

wherein, when multiple AF areas disposed at given positions in the imaging area are set as the AF area, the AF area setting unit sets the AF area to the center again.

(3) The imaging apparatus according to (2),

wherein the AF area setting unit sets the AF area again to the multiple AF areas disposed at the given positions in the center.

(4) The imaging apparatus according to (2),

wherein the AF area setting unit sets the AF area again to one of the AF areas disposed at the given positions in the center.

(5) The imaging apparatus according to any one of (1) to (4), further including:

a subject recognition unit configured to recognize the subject that is the tracking target,

wherein the AF area setting unit sets the AF area again in accordance with a recognition result of the subject recognition unit.

(6) A control method for an imaging apparatus including an imaging unit configured to shoot an image of a subject, the control method including:

setting, by the imaging apparatus, an AF area provided in an imaging area, the AF area being used for deciding a focus position of autofocus on the subject;

controlling, by the imaging apparatus, the autofocus in accordance with the AF area; and

setting, by the imaging apparatus, the AF area again to a center of the imaging area when the subject that is a tracking target is not recognized in a tracking operation using the autofocus.

(7) A program for causing a computer that controls an imaging apparatus including an imaging unit configured to shoot an image of a subject to execute:

setting an AF area provided in an imaging area, the AF area being used for deciding a focus position of autofocus on the subject;

controlling the autofocus in accordance with the AF area; and

setting the AF area again to a center of the imaging area when the subject that is a tracking target is not recognized in a tracking operation using the autofocus.

What is claimed is:

1. An imaging apparatus comprising:
an imaging unit configured to shoot an image of a subject;
an AF area setting unit configured to set an AF area provided in an imaging area, the AF area being used for deciding a focus position of autofocus on the subject; and
an AF control unit configured to control the autofocus in accordance with the AF area,
wherein, when the subject that is a tracking target is not recognized in a tracking operation using the autofocus, the AF area setting unit sets the AF area again to a center of the imaging area.

2. The imaging apparatus according to claim 1,
wherein, when multiple AF areas disposed at given positions in the imaging area are set as the AF area, the AF area setting unit sets the AF area to the center again.

3. The imaging apparatus according to claim 2,
wherein the AF area setting unit sets the AF area again to the multiple AF areas disposed at the given positions in the center.

4. The imaging apparatus according to claim 2,
wherein the AF area setting unit sets the AF area again to one of the AF areas disposed at the given positions in the center.

5. The imaging apparatus according to claim 1, further comprising:
a subject recognition unit configured to recognize the subject that is the tracking target,
wherein the AF area setting unit sets the AF area again in accordance with a recognition result of the subject recognition unit.

6. A control method for an imaging apparatus including an imaging unit configured to shoot an image of a subject, the control method comprising:
setting, by the imaging apparatus, an AF area provided in an imaging area, the AF area being used for deciding a focus position of autofocus on the subject;
controlling, by the imaging apparatus, the autofocus in accordance with the AF area; and
setting, by the imaging apparatus, the AF area again to a center of the imaging area when the subject that is a tracking target is not recognized in a tracking operation using the autofocus.

7. A program for causing a computer that controls an imaging apparatus including an imaging unit configured to shoot an image of a subject to execute:
setting an AF area provided in an imaging area, the AF area being used for deciding a focus position of autofocus on the subject;
controlling the autofocus in accordance with the AF area; and
setting the AF area again to a center of the imaging area when the subject that is a tracking target is not recognized in a tracking operation using the autofocus.
